(19) United States
(12) Patent Application Publication
(10) Pub. No.: US 2022/0396718 A1
(43) Pub. Date: Dec. 15, 2022

(54) TEMPORARY VEHICLE PROTECTION FILM WRAP WITH REVERSE ADHESIVE

(71) Applicants: Ronald Lipson, Orchard Lake, MI (US); Nick Rieser, Warren, MI (US)

(72) Inventors: Ronald Lipson, Orchard Lake, MI (US); Nick Rieser, Warren, MI (US)

(21) Appl. No.: 17/841,332

(22) Filed: Jun. 15, 2022

Related U.S. Application Data
(60) Provisional application No. 63/210,571, filed on Jun. 15, 2021.

(51) Int. Cl. C09J 7/22

(52) U.S. Cl. CPC C09J 7/22; B60J 1/2094

(57) ABSTRACT

The adhesive faces outwardly in a temporary vehicle wrapping film, dramatically improving the process of application. The film may be a durable 3-mil, puncture-resistant plastic film with a UV inhibitor, and the adhesive may be a reduced-tack or “low-tack” adhesive. The base layer and the adhesive are preferably transparent or translucent, and the width of the roll may be in the range of 1 to several feet. A portion of the outwardly facing adhesive is applied to a surface to be protected, enabling the film to be unrolled with the outwardly facing adhesive surface at all times being applied to the surface. The film is cut when the surface to be protected is sufficiently covered. In contrast to existing solutions, the film may be applied by a single user, with one hand grasping one end of the roll and the other hand grasping the other end of the roll.

### REFERENCE TO RELATED APPLICATIONS

This application claims priority to, and the benefit of, U.S. Provisional Patent Application Ser. No. 63/210,571, filed Jun. 15, 2021, the entire content of which is incorporated herein by reference.

### FIELD OF THE INVENTION

This invention relates generally to materials for temporarily protecting vehicles and, in particular, to a vehicle protection film wrap wherein the adhesive surface is reversed facilitating easier application.

### BACKGROUND OF THE INVENTION

There are many instances wherein portions of a vehicle need to be temporarily protected, at least until repairs are made. Such applications include broken windows, collision areas exposing interior spaces, misaligned doors due to theft, and protection from dust and dirt awaiting repair.

A problem with existing protective films, apart from small width and lack of transparency, is that the adhesive is inwardly directed—that is, toward the center of the roll. This makes is difficult to apply the film.

FIG. 1 illustrates the problems associated with applying existing film to a broken windshield 102. In particular, the non-adhesive surface of the roll 104 faces outwardly, with the adhesive surface 106 facing inwardly. This is the obvious way to do it since the adhesive is non-exposed and therefore protected until the film is pulled off the roll. However, as evident in FIG. 1, when the film comes off the top of the roll, placement is problematic, typically requiring one or more other individuals 112, 114, to align and smooth the product during placement. Even with this help, however, areas 116, 118 of overlapping film develop due to the film sticking to itself, resulting in overlapping regions and an unsatisfactory result.

### SUMMARY OF THE INVENTION

This invention addresses and solves such problems associated with the prior art by providing a temporary vehicle wrapping film wherein the adhesive faces outwardly, thereby dramatically improving the process of application.

A protective film for protecting a damaged vehicle or other surfaces according to the invention comprises a base layer of thin plastic film having opposing outer surfaces. One of the opposing outer surfaces of the base layer includes an adhesive, and the other opposing surface does not include an adhesive. The film is provided in roll form with the adhesive surface facing outwardly and away from the center of the roll. The base layer and the adhesive are preferably transparent or translucent. The width of the roll may be in the range of 12″ to 48″.

In use, a portion of the outwardly facing adhesive is applied to a surface to be protected. The film is then unrolled with the outwardly facing adhesive surface at all times being applied to the surface to be protected. The film is cut when the surface to be protected is sufficiently covered. In contrast to existing solutions, the film may be applied by a single user, with one hand grasping one end of the roll and the other hand grasping the other end of the roll.

For example, a user may pull a short (i.e., 2″) starter edge from the roll and press it down against the surface to be protected. Then the user simply grips the roll and begins unwinding the film across and over the damaged area. In some cases, with a smooth uniform surface, the starter edge may not even be required.

The film may be a durable 3-mil, puncture-resistant plastic film with a UV inhibitor, and the adhesive may be a reduced-tack or “low-tack” adhesive. The product adheres to and clean and dry metal, glass or plastic surfaces and cuts easily with razor blade, poly knife or ‘snippet’ knife.

The product provides immediate protection in any situation wherein the vehicle interior may be exposed to risk of damage from wind, rain, dirt, etc., outdoors or indoors. In further contrast to existing solutions, the product comes in different widths up to 48″.

The film described herein provides temporary protection against cracked windshields, broken windows, sprung doors, caved-in roofs and any opening to protect vehicle interior from risk of damage from rain, wind, snow, dirt, etc., outdoors or indoors. Once applied to a dry surface, the film resists precipitation of all kinds.

### BRIEF DESCRIPTION OF THE DRAWINGS

FIG. 1 is drawing that shows an application of an existing protective film illustrating some of the challenges associated therewith; and

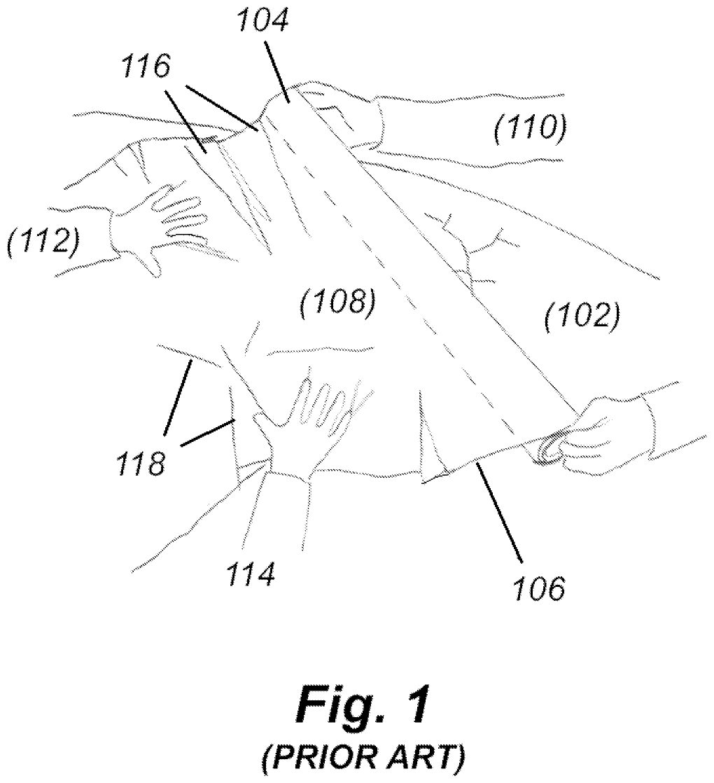

FIG. 2 is drawing that shows the improved application of the inventive, reverse-adhesive protective film described herein.

### DETAILED DESCRIPTION OF THE INVENTION

This invention addresses and solves such problems associated with the prior art by providing a temporary vehicle wrapping film wherein the adhesive faces outwardly, thereby dramatically improving the process of application.

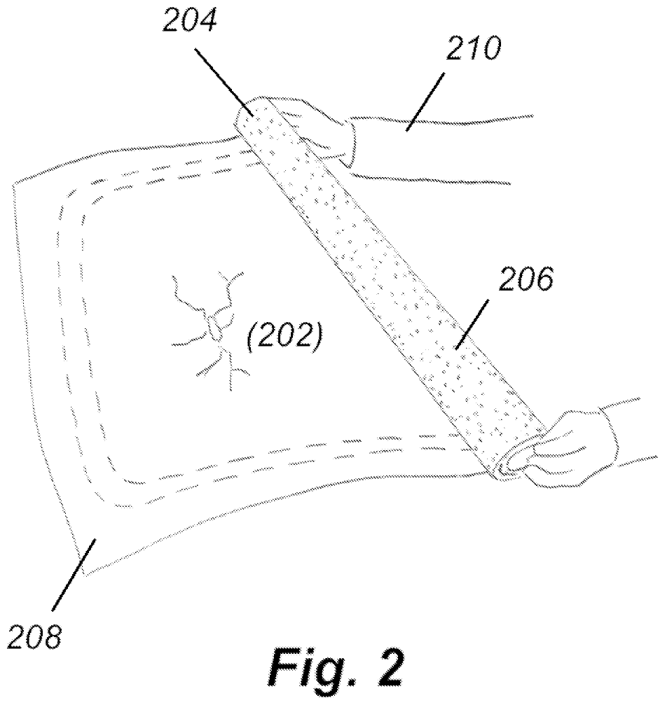

FIG. 2 illustrates this improvement with respect to covering and protecting a portion of a vehicle, again a broken windshield 202. Now, with the adhesive 206 facing outwardly, the user 210, can simply place the roll onto the surface to cover and begin unwinding the roll. The applied film is now immediately adjacent the surface being covered at all times, reducing or eliminating gaps, overlaps and self-adhesion. Note that a single person can now do the job with superior results. The user can simply stop unrolling the film when finished, cutting the film with one hand while holding the roll with the other.

In the preferred embodiments, the film itself is a durable 3-mil, puncture-resistant plastic film with a UV inhibitor. The adhesive is preferably a reduced tack adhesive that keeps the film temporarily adhered to surfaces while permitting straightforward removal without tearing leaving adhesive residue. The product adheres to and clean and dry metal, glass or plastic surfaces and cuts easily with razor blade, poly knife or ‘snippet’ knife.

The product provides immediate protection in any situation wherein the vehicle interior may be exposed to risk of damage from wind, rain, dirt, etc., outdoors or indoors. In further contrast to existing solutions, the product comes in different widths up to 48″, limited only by the distance between the outstretched hands on the individual applying the film. Such wider widths make application to particular areas convenient and easy. As examples, one person may quickly unroll the self-adhering protective in a 36″ width across a damaged windshield, whereas a 24″ width readily covers side windows in one strip.

The film described herein provides temporary protection against cracked windshields, broken windows, sprung doors, caved-in roofs and any opening to protect vehicle interior from risk of damage from rain, wind, snow, dirt, etc., outdoors or indoors. Once applied to a dry surface, the film resists precipitation of all kinds. To apply, a user may pull a short (i.e., 2″) starter edge from the roll and press it down against the surface to be protected. Then the user simply grips the roll and begins unwinding the film across and over the damaged area. In some cases, with a smooth uniform surface, the starter edge may not even be required.

1. A protective film for protecting a damaged vehicle or other surfaces, comprising:
a base layer of thin plastic film having opposing outer surfaces;
wherein one of the opposing outer surfaces of the base layer includes an adhesive and the other opposing surface does not include an adhesive; and
wherein the film is provided in roll form with the adhesive surface facing outwardly and away from the center of the roll.

2. The protective film of claim 1, wherein the base layer and adhesive are transparent or translucent.

3. The protective film of claim 1, wherein the width of the roll is in the range of 12″ to 48″.

4. A method of protecting a surface, comprising the steps of:
providing the protective film of claim 1;
adhering a portion of the outwardly facing adhesive surface to a surface to be protected;
unrolling the film, with the outwardly facing adhesive surface at all times being applied to the surface to be protected; and
cutting the film when the surface to be protected is sufficiently covered.

5. The method of claim 4, wherein the step of adhering a portion of the outwardly facing adhesive surface to a surface to be protected includes adhering a starting strip from the roll.

6. The method of claim 4, wherein the film is applied and cut by a single user.

7. The method of claim 6, wherein the film is applied by a single user with one hand grasping one end of the roll and the other hand grasping the other end of the roll.
